(19) United States
(12) Patent Application Publication
(10) Pub. No.: US 2007/0281618 A1
(43) Pub. Date: Dec. 6, 2007

(54) TRANSMITTER-RECEIVER FOR SHORT-RANGE WIRELESS TRANSMISSION

(75) Inventor: Nobuaki Yokoyama, Tokyo (JP)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: GENERAL RESEARCH OF ELECTRONICS, INC., Tokyo (JP)

(21) Appl. No.: 11/757,036

(22) Filed: Jun. 1, 2007

(30) Foreign Application Priority Data
Jun. 6, 2006 (JP) 2006-157449

(51) Int. Cl. H04B 7/00

(52) U.S. Cl. 455/41.2

(57) ABSTRACT

The present invention provides a transmitter-receiver for short-range wireless transmission, which comprises a frequency scan signal receiving section that searches a vacant channel frequency by frequency scanning of a receiving wave, and a signal transmitting section that transmits a transmitting wave using the searched vacant channel frequency. The frequency scan signal receiving section sequentially changes a frequency of a PLL oscillator by control of a controller to thereby search the presence or absence of a receive frequency lying in a predetermined frequency band depending on an output state of a carrier detector. When the controller detects a vacant channel frequency, the frequency scan signal receiving section fixes the oscillation frequency of the PLL oscillator to an oscillation frequency corresponding to the vacant channel frequency and supplies the fixed oscillation frequency to the signal transmitting section. The signal transmitting section forms a transmit signal with the supplied oscillation frequency as a local oscillation signal and transmits the transmit signal having the same channel frequency as the vacant channel frequency as a transmitting wave.

### BACKGROUND OF THE INVENTION

1. Field of the Invention

The present invention relates to a transmitter-receiver for short-range wireless transmission, and particularly to a transmitter-receiver for short-range wireless transmission, comprising a frequency scan signal receiving section and a signal transmitting section, wherein prior to the transmission of information such as voice, music, data and the like from the signal transmitting section, the frequency scan signal receiving section scans a received signal frequency band to detect a vacant channel in the corresponding frequency band and automatically sets a transmission frequency of the signal transmitting section to the vacant channel frequency.

2. Description of the Related Art

In general, the transmission of a weak wave from a signal transmitter and the transmission of information such as voice, music, data and the like to a signal receiver located near the signal transmitter need not to obtain a license for the transmission/reception thereof, and anybody can perform its transmission/reception with ease. Therefore, many users make use of it. In this case, there is a need to select a frequency equivalent to a gap or clearance between used wave frequencies in such a manner that the frequency of the weak wave usable in the transmission/reception doe not overlap with various wave frequencies already available at their corresponding spots. This is because there is a possibility that when such frequency setting is not done, the transmitted weak wave is greatly affected by interference from the various waves and hence the weak wave will not be able to be transmitted/received. Therefore, it has normally been practised to perform a search for clearances by a frequency scan signal receiver before the signal transmitter for transmitting the weak wave is operated, and set a transmission frequency to a frequency (frequency channel) free of the presence of various interference waves.

On the other hand, the signal transmitter for transmitting such a weak wave needs to be able to change a transmit signal frequency to an arbitrary frequency lying in its frequency band. To this end, the signal transmitter makes use of either means for varying the frequency by a simple self-excited oscillator having an LC resonant circuit or means for varying the frequency by a PLL (Phase-Locked Loop) synthesizer oscillator.

In this case, the means using the self-excited oscillator in the signal transmitter is simple in circuit configuration and low in manufacturing cost but is not substantially good in oscillation frequency accuracy and oscillation frequency stability. On the other hand, the means using the PLL synthesizer oscillator in the signal transmitter is excellent in oscillation frequency accuracy and oscillation frequency stability to a problem-free degree but is complicated in circuit configuration and high in manufacturing cost correspondingly.

### SUMMARY OF THE INVENTION

The present invention has been made on the basis of such a technological background. An object of the present invention is to provide a transmitter-receiver for short-range wireless transmission, wherein a frequency scan signal receiver and a signal transmitter are integrally configured, and a PLL synthesizer oscillator employed in the frequency scan signal receiver is shared for the signal transmitter, thereby simplifying a circuit configuration thereof and lowering the cost of its production.

In order to attain the above object, there is provided a transmitter-receiver for short-range wireless transmission, which comprises a frequency scan signal receiving section which searches a vacant channel frequency by frequency scanning of a receiving wave, and a signal transmitting section which transmits a transmitting wave using the searched vacant channel frequency. The frequency scan signal receiving section sequentially changes an oscillation frequency of a local oscillator constituting a PLL by control of a controller to thereby search the presence or absence of a receive frequency lying in a predetermined frequency band depending on an output state of a carrier detector, and, when the controller detects a vacant channel frequency by the search thereof, fixes the oscillation frequency of the local oscillator to an oscillation frequency corresponding to the vacant channel frequency and supplies the fixed oscillation frequency to the signal transmitting section. The signal transmitting section is provided with constituting means which performs frequency conversion of a transmit signal using the supplied oscillation frequency as a local oscillation frequency to thereby form a transmit signal having the same channel frequency as the vacant channel frequency, and transmits the formed transmit signal as a transmitting wave.

In the constituting means, the signal transmitting section includes a voltage-controlled oscillator whose oscillation signal is modulated by a modulation signal, and a modulator which frequency-mixes the modulated oscillation signal of the voltage-controlled oscillator and the oscillation frequency corresponding to the vacant channel frequency. The modulator outputs a transmit signal having the same channel frequency as the vacant channel frequency therefrom. In this case, the modulator may preferably be an analog multiplier.

In the constituting means, the frequency scan signal receiving section can take a configuration including a first frequency converting unit which frequency-mixes a received signal and an oscillation frequency of the local oscillator to form a first intermediate frequency signal, and a second frequency converting unit which frequency-mixes the first intermediate frequency signal and an oscillation frequency of a second local oscillator to form a second intermediate frequency signal.

Further, in the constituting means, the frequency scan signal receiving section includes variable control switch means which is provided between a demodulator circuit and a low frequency amplifier and selectively outputs a demodulated signal supplied from the demodulator circuit and a modulated signal supplied from the signal transmitting section to the low frequency amplifier. The controller includes such a configuration as to supply a switching voltage to the variable control switch means upon a search for a vacant channel frequency thereby to allow the variable control switch means to perform switching from the previously taken output of the demodulated signal to the output of the modulated signal.

The constituting means is obtained based on the following principle of operation. That is, a local oscillation frequency formed by a PLL synthesizer oscillator of a frequency scan signal receiving section is set to a frequency higher by an intermediate frequency than a received signal frequency or set to a frequency lower by the intermediate frequency than the received signal frequency. Adding the local oscillation frequency and the intermediate frequency where, for example, the local oscillation frequency is assumed to be the frequency lower by the intermediate frequency than the received signal frequency yields the received signal frequency in reverse.

Thus, when a vacant channel frequency is detected in the process of scanning channel frequencies lying within a predetermined frequency band one after another to thereby detect the presence or absence of a received signal while the setting of a division ratio of a divider used in the PLL synthesizer oscillator is being changed, the scanning is stop at the channel frequency and the oscillation frequency is fixed to a local oscillation frequency at that time. On the other hand, an oscillator for allowing a frequency equal to an intermediate frequency to oscillate is provided on the signal transmitting section side. When an oscillation output of the oscillator and an oscillation output of the PLL synthesizer oscillator are added to a modulator and subjected to a multiplying process, a transmit signal having the same channel frequency as a vacant channel frequency can be obtained at the output of the modulator.

As described above in detail, when a weak wave is transmitted from a signal transmitter, it has heretofore been necessary to set the operation of matching a transmission frequency of the signal transmitter with a vacant channel frequency after the vacant channel frequency has been detected using a frequency scan signal receiver. According to a transmitter-receiver for short-range wireless transmission, however, advantageous effects are brought about in that there is obtained a transmitter-receiver for short-range wireless transmission, wherein a signal transmitting section and a frequency scan signal receiving section are integrally configured, and since a weak radio wave having the same channel frequency as a vacant channel frequency can immediately be transmitted using an oscillation output of a PLL synthesizer oscillator when the vacant channel frequency is detected by scanning of a received signal at the frequency scan signal receiving section, the entire circuit configuration is extremely simple and the operation and setting of a transmission frequency on the signal transmitting section side are not necessary, thereby making its operation easy and lowering its manufacturing cost.

Other features and advantages of the present invention will become apparent upon a reading of the attached specification.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 relates to an embodiment of a transmitter-receiver for short-range wireless transmission according to the present invention and is a block circuit diagram showing a configuration of its essential part.

### DETAILED DESCRIPTION OF THE PREFERRED EMBODIMENTS

The present invention will be explained hereinafter with reference to the accompanying drawings.

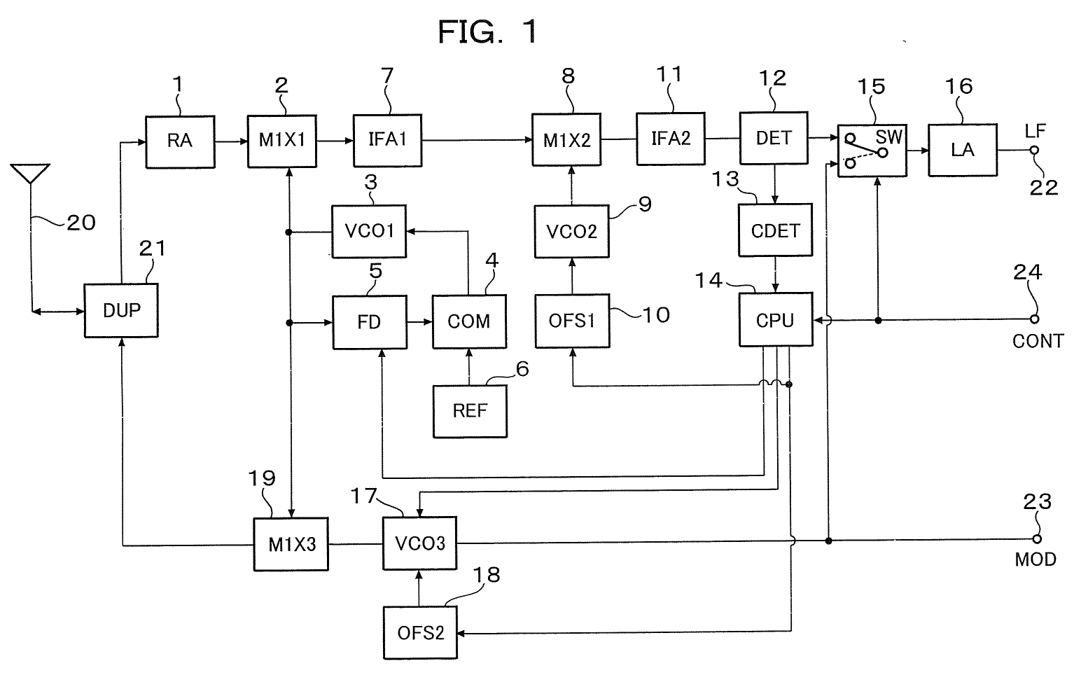

FIG. 1 relates to an embodiment of a transmitter-receiver for short-range wireless transmission according to the present invention, and is a block circuit diagram showing a configuration of its essential part.

As shown in FIG. 1, the transmitter-receiver for short-range wireless transmission according to the present embodiment comprises a frequency scan signal receiving section R, a signal transmitting section T and a transmission-reception sharing section C.

In this case, the frequency scan signal receiving section R comprises a high frequency amplifier (RA) 1, a first mixer stage (MIX1) 2, a first voltage-controlled oscillator (VCO1) 3, a phase comparator (COM) 4, a frequency divider (FD) 5, a reference frequency oscillator (REF) 6, a first intermediate frequency amplifier (IFA1) 7, a second mixer stage (MIX1) 8, a second voltage-controlled oscillator (VCO2) 9, a first offset voltage generator (OFS1) 10, a second intermediate frequency amplifier (IFA1) 11, a demodulator (DET) 12, a carrier detector (CDET) 13, a controller (CPU) 14, a selector switch (SW) 15, and a low frequency amplifier (LA) 16. The signal transmitting section T comprises a third voltage-controlled oscillator (VCO3) 17, a first offset voltage generator (OFS2) 18, and a third mixer stage (MIX3) 19. Further, the transmission-reception sharing section C comprise a transmitting/receiving antenna 20, a duplexer (DUP) 21, a low-frequency signal output terminal 22, a modulation signal input terminal 23 and a control signal input/output terminal 24. Incidentally, a section comprising the first voltage-controlled oscillator 3, phase comparator 4 and frequency divider 5 of the scan signal receiving section R constitutes a PLL synthesizer oscillation circuit.

In the frequency scan signal receiving section R, the high frequency amplifier 1 has an input end connected to an output end of the duplexer 21 of the transmission-reception sharing section C and an output end connected to a first input end of the first mixer stage 2. The first mixer stage 2 has a second input end connected to an output end of the first voltage-controlled oscillator 3 and an input end of the frequency divider 5, and an output end connected to an input end of the first intermediate frequency amplifier 7. The firs voltage-controlled oscillator 3 has an input end connected to an output end of the phase comparator 4. The phase comparator 4 has a first input end connected to an output end of the frequency divider 5, and a second input end connected to an output end of the reference frequency generator 6. The frequency divider 5 has a control end connected to a first output end of the controller 14. The first intermediate frequency amplifier 7 is connected to a first input end of the second mixer stage 8. The second mixer stage 8 has a second input end connected to an output end of the second voltage-controlled oscillator 9, and an output end connected to an input end of the second intermediate frequency amplifier 11. The second voltage-controlled oscillator 9 has a control end connected to an output end of the first offset voltage generator 10. The first offset voltage generator 10 has a control end connected to a third output end of the controller 14. The second intermediate frequency amplifier 11 has an output end connected to an input end of the demodulator 12. The demodulator 12 has a first output end connected to a first input end of the selector switch 15, and a second output end connected to an input end of the carrier detector 13. The carrier detector 13 has an output end connected to an input end of the controller 14. The controller 14 has a second output end connected to an input end of the third voltage-controlled oscillator 17 of the signal transmitting section T, and a control end connected to a control end of the selector switch 15 and the control signal input/output terminal 24 of the transmission-reception sharing section C. The selector switch 15 has a second input end connected to the modulation signal input terminal 23 of the transmission-reception sharing section C, and an output end connected to an input end of the low frequency amplifier 16. The low frequency amplifier 16 has an output end connected to the low-frequency signal output terminal 22 of the transmission-reception sharing section C.

The third voltage-controlled oscillator 17 in the signal transmitting section T has an input end connected to the modulation signal input terminal 23 of the transmission-reception sharing section C, a first control end connected to the third output end of the controller 14 of the frequency scan signal receiving section R, a second control end connected to an output end of the second offset voltage generator 18, and an output end connected to a first input end of the third mixer stage 19. The second offset voltage generator 18 has a control end connected to the third output end of the controller 14 in the frequency scan signal receiving section R. The third mixer stage 19 has a second input end connected to the output end of the first voltage-controlled oscillator 3 in the frequency scan signal receiving section R, and an output end connected to an input end of the duplexer 21. Further, the duplexer 21 in the transmission-reception sharing section C has an input/output end connected to the transmitting/receiving antenna 20.

The transmitter-receiver for short-range wireless transmission according to the present configuration is operated as follows:

When a radiowave signal is received by the transmitting/receiving antenna 20, the received signal is inputted to the frequency scan signal receiving section R through the duplexer 21. The frequency scan signal receiving section R amplifies the input received signal with the high frequency amplifier 1 and supplies the amplified received signal to the first input end of the first mixer stage 2. The first mixer stage 2 is supplied, at its second input end, with a first local oscillation signal oscillated by the PLL synthesizer oscillation circuit constituted of the first voltage-controlled oscillator 3, the phase comparator 4 and the frequency divider 5. The first mixer stage 2 frequency-mixes the received signal and the first local oscillation signal together and supplies the thus frequency-mixed output to the first intermediate frequency amplifier 7. In this case, the frequency of the first local oscillation signal generated by the PLL synthesizer oscillation circuit is set by the frequency divider 5 whose frequency ratio is controlled by the controller 14.

The first intermediate frequency amplifier 7 extracts a first intermediate frequency signal from the supplied frequency-mixed output by its amplification and supplies the extracted first intermediate frequency signal to the first input end of the second mixer stage 8. The second mixer stage 8 is supplied with a second local oscillation signal oscillated by the second voltage-controlled oscillator 9 at its second input end. The second mixer stage 8 frequency-mixes the first intermediate frequency signal and the second local oscillation signal together and supplies the thus frequency-mixed output to the second intermediate frequency amplifier 11. At this time, the frequency of the second local oscillation signal produced by the second voltage-controlled oscillator 9 is set by the controller 14 which performs frequency control through the first offset voltage generator 10. Incidentally, the function of the first offset voltage generator 10 will be described later.

The second intermediate frequency amplifier 11 extracts a second intermediate frequency signal from the supplied frequency-mixed output by its amplification and supplies the extracted second intermediate frequency signal to the demodulator 12. The demodulator 12 demodulates the second intermediate frequency signal to extract a low frequency signal contained therein. The extracted low frequency signal is supplied via the selector switch 15 to the low frequency amplifier 16, where it is amplified, followed by being supplied to the low-frequency signal output terminal 22. At this time, the carrier detector 13 detects a carrier signal component from the second intermediate frequency signal supplied to the demodulator 12. When the carrier signal component is detected, the carrier detector 13 supplies a detection signal to the controller 14. On the other hand, when no carrier signal component is detected, the carrier detector 13 supplies a non-detection signal to the controller 14.

Operation at the frequency scan of the received signal, which is carried out by the frequency scan signal receiving section R, will now be explained.

The frequency scan of the received signal is performed by sweeping and changing the frequency of the first local oscillation signal generated from the PLL synthesizer oscillation circuit. The controller 14 sequentially changes the setting of a division ratio of the frequency divider 5 of the PLL synthesizer oscillation circuit and thereby sweeps and changes the frequency of the first local oscillation signal generated from the PLL synthesizer oscillation circuit.

Incidentally, an integer is normally used as the division ratio set to the frequency divider 5. The frequency of the first local oscillation signal is set to a signal frequency equal to an integral multiple of a reference frequency generated by the reference frequency generator 6. The reference frequency generated by the reference frequency generator 6 is selected to each of frequencies respectively equal to frequency intervals (channel spacing) assigned radio waves at their corresponding received-signal frequency bands.

Thus, assuming now that the channel spacing is set to, for example, 10 kHz, respective channel frequencies assigned to an actual received signal are set to 10 kHz intervals as in the case of 105 kHz, 115 kHz, 125 kHz, . . . . Therefore, the first local oscillation signal frequency at this time is changed to 10 kHz intervals as in the case of 70 kHz, 80 kHz, 90 kHz, . . . . As a result, a first intermediate frequency is set to 35 kHz. When the frequency of the received signal falls into a frequency band in the neighborhood of 200 kHz, the respective channel frequencies assigned to the actual received signal are set to 10 kHz intervals as in the case of 202.5 kHz, 212.5 kHz, 222.5 kHz, . . . . The first local oscillation signal frequency is changed to 10 kHz intervals as in the case of 170 kHz, 180 kHz, 190 kHz, . . . . As a result, the first intermediate frequency is set to 32.5 kHz.

In this case, it has been previously known about whether each channel frequency is set according to the received signal frequency in a state indicative of to which extent it has caused a frequency deviation from the frequency equal to the integral multiple of the reference frequency. Therefore, when each channel frequency corresponding to the received signal frequency is set, the controller 14 sets the division ratio of the frequency divider 5 in such a manner that it becomes a division ratio corresponding to the corresponding channel frequency. Further, when a frequency control voltage for controlling the second voltage-controlled oscillator 9 is supplied, the controller 14 adds an offset voltage selectively generated by the first offset voltage generator 10 to the frequency control voltage, thereby generating a first local oscillation signal frequency frequency-offset by a predetermined frequency deviation. Therefore, even when the received signal frequency is scanned at any channel frequency, a second intermediate frequency signal outputted from the second mixer stage 8 and selected and amplified by the second intermediate frequency amplifier 11 is set in such a manner that the correct second intermediate frequency is always held.

Thereafter, the second intermediate frequency signal selected and amplified by the second intermediate frequency amplifier 11 is demodulated by the demodulator 12, and the demodulated low frequency signal is amplified by the low frequency amplifier 16 through the selector switch 15, followed by being outputted to an available circuit (not shown) through the low-frequency signal output terminal 22. At this time, the carrier detector 13 detects whether the received signal exists in a channel during reception, and supplies the result of detection thereof to the controller 14.

When the carrier detector 13 detects that the received signal exists, upon execution of the single operation of the frequency scan signal receiving section R, the controller 14 fixes the setting of the division ratio of the frequency divider 5 to a setting at that time and allows the frequency scan signal receiving section R to receive the corresponding reception channel frequency continuously. On the other hand, when the carrier detector 13 detects that no received signal exists, the controller 14 sets and changes the division ratio of the frequency divider 5 to a division ratio for receiving the next channel frequency. Thereafter, the controller 14 sequentially changes the setting of the division ratio of the frequency divider 5 to the following settings until the carrier detector 13 detects the presence of the received signal.

On the other hand, when the signal transmitting section T is operated together with the frequency scan signal receiving section R, a control operation opposite to that at the time that the frequency scan signal receiving section R is singly operated, is carried out. That is, when the absence of the received signal is detected by the carrier detector 13, the controller 14 fixes the setting of the division ratio of the frequency divider 5 to a setting at that time and brings the frequency scan signal receiving section R to a state of continuously receiving the corresponding reception channel frequency. On the other hand, when the presence of the received signal is detected by the carrier detector 13, the controller 14 sets and changes the division ratio of the frequency divider 5 to a division ratio for receiving the next channel frequency. Thereafter, the controller 14 sequentially changes the setting of the division ratio of the frequency divider 5 to the following settings until the carrier detector 13 detects the absence of the received signal.

When the absence of the received signal is detected by the carrier detector 13 and thereby the setting of the division ratio of the frequency divider 5 is fixed to the setting at that time, the controller 14 sets and changes the third voltage-controlled oscillator 17 of the signal transmitting section T from a non-operating state to an operating state. Consequently, the third voltage-controlled oscillator 17 generates a transmission carrier signal having a frequency equal to the frequency of the first intermediate frequency signal of the frequency scan signal receiving section R in response to a frequency control voltage supplied from the controller 14.

In this case, the controller 14 supplies a control voltage to the second offset voltage generator 18 as long as the channel frequency of the received signal is placed in a state in which the offset voltage supplied from the first offset voltage generator 10 is being added to the control voltage for frequency-controlling the second voltage-controlled oscillator 9, thereby allowing the second offset voltage generator 18 to generate an offset voltage. Then, the second offset voltage generator 18 adds the offset voltage at this time to the frequency control voltage and supplies the result of addition to the third voltage-controlled oscillator 17. Consequently, the third voltage-controlled oscillator 17 oscillates a transmission carrier signal frequency-offset by a predetermined frequency deviation. On the other hand, if the channel frequency of the received signal is in a state in which the offset voltage supplied from the first offset voltage generator 10 is not being added to the control voltage for frequency-controlling the second voltage-controlled oscillator 9, then the offset voltage is not added to the frequency control voltage supplied to the third voltage-controlled oscillator 17 and hence the third voltage-controlled oscillator 17 oscillates a transmission carrier signal corresponding to the frequency control voltage.

Thereafter, when the transmission carrier signal oscillated by the third voltage-controlled oscillator 17 and the first local oscillation signal outputted from the PLL synthesizer oscillation circuit of the frequency scan signal receiving section R are supplied to the modulator 19 in the signal transmitting section T, the modulator 19 modulates, e.g., amplitude-modulates the transmission carrier signal in accordance with the first local oscillation signal and leads out a transmit signal having the same channel frequency as a vacant channel frequency therefrom. The transmit signal that is led out therefrom is supplied to the transmitting/receiving antenna 20 via the duplexer 21 and transmitted from the transmitting/receiving antenna 20 as a weak radio wave.

If, at this time, a modulation signal made up of information such as voice, music, data and the like supplied from the modulation signal input terminal 23 is supplied to the third voltage-controlled oscillator 17 of the signal transmitting section T, then the transmission carrier signal to be oscillated is modulated, e.g., frequency-modulated with the modulation signal by the third voltage-controlled oscillator 17. Therefore, the frequency-modulated transmit signal having the same channel frequency as the vacant channel frequency is led out to the output of the modulator 19 and transmitted through the transmitting/receiving antenna 20.

Incidentally, since the transmit signal having the same channel frequency as the vacant channel frequency may be formed at the modulator 19, a circuit configuration and a modulation format of the modulator 19 may basically be any one. However, an amplitude modulator is used as the simplest means in terms of the circuit configuration.

The above embodiment has bee explained by citing the example in which the frequency of the first local oscillation signal is set lower by the frequency of the first intermediate frequency signal than the received signal frequency, and the addition of the frequency of the first intermediate frequency signal to the first local oscillation signal frequency yields the received signal frequency. In the present example, when the modulator 19 amplitude-modulates the transmission carrier signal oscillated by the third voltage-controlled oscillator 17, which is equal to the first intermediate frequency signal, in accordance with the first local oscillation signal, an upper sideband having a frequency component equal to the first local oscillation signal frequency and a frequency component equal to the received signal frequency with its frequency as the center, and a lower sideband having a frequency component set lower by a frequency equal to the frequency of the first intermediate frequency signal from the frequency of the transmission carrier signal are produced from the output of the modulator 19. Since transmission power having these three frequency components is weak power free of the need for a license even though considered together, the transmission power can be transmitted through the transmitting/receiving antenna 20 as it is and hence the upper sideband is received by other receivers.

While the output signal of the modulator 19 may be transmitted from the transmitting/receiving antenna 20 as it is in this case, the frequency component equal to the first local oscillation signal frequency and the frequency component corresponding to the lower sideband are originally unnecessary. Therefore, it is preferable to use an analog multiplier as the modulator 19 and insert a bandpass filter for removing unnecessary frequency components between the modulator 19 and the duplexer 21. Further, if slight complication of a circuit configuration of the modulator 19 is allowed, then an SSB (Single-Side Band) modulator constituted using two ring modulators and two 90° phase shifters can also be configured for the modulator 19.

Incidentally, the third voltage-controlled oscillator 17 in the signal transmitting section T produces the oscillation signal frequency which is equal to the frequency of the first intermediate frequency signal in the frequency scan signal receiving section R. Thus, when the oscillation signal of the third voltage-controlled oscillator 17 is mixed into a first intermediate frequency circuit during the single operation of the frequency scan signal receiving section R, it becomes a strong or powerful interference signal, so that processing of the received signal might be made impossible. Therefore, the signal transmitting section T needs to set the third voltage-controlled oscillator 17 to a non-operating state perfectly when no transmitting operation is done.

The selector switch 15 used in the frequency scan signal receiving section R switches a moving contact in response to a control signal led out from the controller 14 and loops back the modulation signal selectively. The low frequency signal outputted from the demodulator 12 and the modulation signal supplied from the modulation signal input terminal 23 are inputted to the selector switch 15. These signals are selectively supplied to the low frequency amplifier 16 through the selector switch 15. That is, when the moving contact of the selector switch 15 is switched to a solid-line state, the demodulated low frequency signal of received signal is supplied to the low frequency amplifier 16 from which the reproduction or the like of the low frequency signal can be carried out. On the other hand, when the moving contact of the selector switch 15 is switched to a dotted-line state, the modulation signal is supplied to the low frequency amplifier 16 through the selector switch 15, so that it is brought to a loop-back state. Thus, the reproduction or the like of the modulation signal is performed so that confirmation or the like of its contents can be carried out.

Although the above embodiment has been explained as mentioned above by citing the example in which the first local oscillation signal frequency is set lower by the frequency of the first intermediate frequency signal than the received signal frequency, and the addition of the frequency of the first intermediate frequency signal to the first local oscillation signal frequency yields the received signal frequency, the present invention is not limited to such an example. If the first local oscillation signal frequency is modulated with the transmission carrier signal of the third voltage-controlled oscillator 17, having the frequency equal to the frequency of the first intermediate frequency signal even where the local oscillation signal frequency is set higher by the frequency of the first intermediate frequency signal than the received signal frequency, a transmit signal having the same channel frequency as a vacant channel frequency is obtained.

Although the above embodiment has been explained by citing the example of a double superheterodyne configuration using the two mixer stages 2 and 8, which is used as the configuration of the frequency scan signal receiving section R, it is needless to say that a single superheterodyne configuration using only one mixer stage may be taken if a frequency band of a received signal at the frequency scan signal receiving section R is assumed to be a relatively narrow range.

Incidentally, a received signal strength indicator (RSSI) may be used as the carrier detector 13 used in the above embodiment as an alternative to the normally-used carrier detector 13.

While the preferred form of the present invention has been described, it is to be understood that modifications will be apparent to those skilled in the art without departing from the spirit of the invention. The scope of the invention is to be determined solely by the following claims.

What is claimed is:

1. A transmitter-receiver for short-range wireless transmission, comprising:
a frequency scan signal receiving section which searches a vacant channel frequency by frequency scanning of a receiving wave; and
a signal transmitting section which transmits a transmitting wave using the searched vacant channel frequency,
wherein the frequency scan signal receiving section sequentially changes an oscillation frequency of a local oscillator constituting a PLL by control of a controller to thereby search the presence or absence of a receive frequency lying in a predetermined frequency band depending on an output state of a carrier detector, and, when the controller detects a vacant channel frequency by the search thereof, fixes the oscillation frequency of the local oscillator to an oscillation frequency corresponding to the vacant channel frequency and supplies the fixed oscillation frequency to the signal transmitting section, and
wherein the signal transmitting section performs frequency conversion of a transmit signal using the supplied oscillation frequency as a local oscillation frequency to thereby form a transmit signal having the same channel frequency as the vacant channel frequency, and transmits the formed transmit signal as a transmitting wave.

2. The transmitter-receiver for short-range wireless transmission according to claim 1, wherein the signal transmitting section includes a voltage-controlled oscillator whose oscillation signal is modulated by a modulation signal, and a modulator which frequency-mixes the modulated oscillation signal of the voltage-controlled oscillator and the oscillation frequency corresponding to the vacant channel frequency, and the modulator outputs a transmit signal having the same channel frequency as the vacant channel frequency therefrom.

3. The transmitter-receiver for short-range wireless transmission according to claim 2, wherein the modulator is an analog multiplier.

4. The transmitter-receiver for short-range wireless transmission according to claim 1, wherein the frequency scan signal receiving section includes a first frequency converting unit which frequency-mixes a received signal and an oscillation frequency of the local oscillator to form a first intermediate frequency signal, and a second frequency converting unit which frequency-mixes the first intermediate frequency signal and an oscillation frequency of a second local oscillator to form a second intermediate frequency signal.

5. The transmitter-receiver for short-range wireless transmission according to claim 1, wherein the frequency scan signal receiving section includes variable control switch means which is provided between a demodulator circuit and a low frequency amplifier and selectively outputs a demodulated signal supplied from the demodulator circuit and a modulated signal supplied from the signal transmitting section to the low frequency amplifier, and
wherein the controller supplies a switching voltage to the variable control switch means upon a search for a vacant channel frequency thereby to allow the variable control switch means to perform switching from the previously-taken output of the demodulated signal to the output of the modulated signal.
